(19) United States
(12) Patent Application Publication
(10) Pub. No.: US 2010/0054355 A1
(43) Pub. Date: Mar. 4, 2010

(54) Wireless communication system

(75) Inventors: Shigenori Kinjo, Kure-shi (JP); Hiroshi Ochi, Kitakyushu-shi (JP)

Correspondence Address: WENDEROTH, LIND & PONACK, L.L.P., 1030 15th Street, N.W.,, Suite 400 East, Washington, DC, 20005-1503, US

(73) Assignee: KYUSHU INSTITUTE OF TECHNOLOGY AND RADRIX CO., LTD

(21) Appl. No.: 12/320,514

(22) Filed: Jan. 28, 2009

(30) Foreign Application Priority Data
Sep. 4, 2008 (JP) JP2008-227454

(51) Int. Cl. H04J 11/00

(52) U.S. Cl. 375/262

(57) ABSTRACT

In a wireless communication system including a radio-signal receiver and a radio-signal transmitter, the radio-signal receiver includes a unit for making a generalized inverse matrix for carrying out maximum likelihood estimation, based on a matrix indicating a training series used for carrying out channel estimation, a unit for carrying out singular value decomposition to the generalized inverse matrix, a unit for truncating singular values in the generalized inverse matrix in accordance with a threshold by which a singular value is turned to zero in a greater order, a unit for estimating an impulse-response vector, based on the generalized inverse matrix, a unit for interpolating zero to the impulse-response vector, and a unit for acquiring channel estimation by carrying out Fourier transform, and the radio-signal transmitter includes a unit for quantifying spread of the singular values, and optimizing the training series in accordance with the quantified spread of the singular values, to thereby make a new training series.

### FIELD OF THE INVENTION

The invention relates to a wireless communication system operating in accordance with MIMO-OFDM (Multiple Input Multiple Output-Orthogonal Frequency Division Multiplexing), a method of making wireless communication between a radio-signal receiver including at least two antennas and a radio-signal transmitter including at least two antennas in accordance with OFDM, a method of receiving radio-signals in a radio-signal receiver including at least two antennas from a radio-signal transmitter including at least two-antennas in wireless communication made in accordance with OFDM, a computer-readable storage medium containing a set of instructions for causing a computer to carry out the method, a method of transmitting radio-signals from a radio-signal transmitter including at least two antennas to a radio-signal receiver including at least two antennas in wireless communication made in accordance with OFDM, and a computer-readable storage medium containing a set of instructions for causing a computer to carry out the method.

### DESCRIPTION OF THE RELATED ART

Recently, in order to achieve wireless communication to be made at a rate greater than 100 Mbps, an attempt has been made to introduce a wireless communication system using a plurality of antennas for receiving and transmitting radio-signals in accordance with MIMO-OFDM, into the next generation wireless communication system as a standard (for instance, see the non-patent references 1 and 2).

Since a plurality of antennas is simultaneously used for transmitting and receiving radio-signals in MIMO-OFDM system, if radio-signals were transmitted at the same power as the power to be consumed when radio-signals are transmitted through a single antenna, power for transmitting radio-signals per an antenna would be reduced. However, it is considered that a radio-signal receiver is frequently used under a low SNR (Signal to Noise Ratio), because the range can be increased by virtue of gain enhancement caused by high-performance error correction to be made by LDPC (Low-Density Parity-Check), for instance.

In MIMO, channel estimation is carried out for reproducing original signals based on radio-signals which had interfered with each other having been transmitted from antennas. If a radio-signal receiver is used under a low-SNR environment, accuracy with which channel estimation is carried out deteriorates, because SNR of reference signals such as pilot signals or preambles to be used for carrying out channel estimation is made smaller. In such condition, it may be impossible to adequately have advantages brought by antenna diversity and/or high-performance error correction.

Hereinbelow is explained a radio-signal transmitter operating in accordance with MIMO-OFDM system, with reference to FIG. 1.

The illustrated radio-signal transmitter is designed to include two antennas for transmitting radio-signals. It should be noted that a radio-signal transmitter including three or more antennas operates in the same way as the illustrated radio-signal transmitter.

A related radio-signal transmitter 10x illustrated in FIG. 1 includes a channel coding section 100, a first preamble producer 110, a second preamble producer 120, a first modulator 111, a second modulator 121, a first inverse Fourier transform section 112, a second inverse Fourier transform section 122, a first multiplexer 113, a second multiplexer 123, a first GI (Guard Interval) adder 114, a second GI adder 124, a first signal-transmission antenna 115, and a second signal-transmission antenna 125.

In FIG. 1, a radio-signal transmitting section for converting bit data having been produced as signal-transmission frames into radio-signals is not illustrated.

The operation of the radio-signal transmitter 10x is explained hereinbelow.

First, the channel coding section 100 adds redundancy to bit data d₁ and d₂, that is, data to be transmitted. Then, the first and second modulators 111 and 121 apply digital modulation such as BPSK (Binary Phase Shift Keying), QPSK (Quadrature Phase Shift Keying) or M-QAM (M-Quadrature Amplitude Modulation) to the bit data d₁ and d₂, respectively.

The thus digitally modulated bit data d₁ and d₂ are converted into time domain signals by the first and second inverse Fourier transform sections 112 and 122, respectively.

The first and second preamble producers 110 and 120 produce long preambles (hereinafter, referred to simply as “LP”) as series having time domains different from each other.

The first and second multiplexer 113 and 123 put the long preambles at a head of signal-transmission frames as a LP part.

Then, the first and second GI adders 114 and 124 add guard interval (hereinafter, referred to simply as “GI”) to each of OFDM symbols.

Then, the radio-signals are transmitted through the first and second antennas 115 and 125.

Hereinbelow is explained a radio-signal receiver operating in accordance with MIMO-OFDM system, with reference to FIG. 2.

A related radio-signal receiver 20x illustrated in FIG. 2 includes an error correction section 200, a maximum likelihood estimation section 201, a first Fourier transform section 210, a second Fourier transform section 220, a first channel estimation section 211x, a second channel estimation section 221x, a first demultiplexer 212, a second demultiplexer 222, a first GI-remover 213, a second GI-remover 223, a first signal-receipt antenna 214, and a second signal-receipt antenna 224.

In FIG. 2, a radio-signal receiving section for converting received radio-signals into bit data is not illustrated.

The operation of the radio-signal receiver 20x is explained hereinbelow.

First, synchronous acquisition is applied to radio-signal frames having been received through the first and second signal-receipt antennas 214 and 224. Then, the first and second GI-removers 213 and 223 remove GIs out of the received radio-signals frames.

The radio-signal frames out of which GIs have been removed are demultiplexed into LP part and data part by the first and second demultiplexers 212 and 222. LP part is used for estimating a transmission-path parameter in the first and second channel estimation sections 211x and 221x. Data part is converted into frequency domains in the first and second Fourier transform sections 210 and 220. The maximum likelihood estimation section 201 estimates a maximum likelihood of signals to be transmitted, based on the signals supplied from the first channel estimation section 211x, the second channel estimation section 221x, the first Fourier transform section 210, and the second Fourier transform section 220. Then, the error correction section 200 reproduces bit data having been transmitted from the radio-signal transmitter 10x, based on the maximum likelihood estimation transmitted from the maximum likelihood estimation section 201.

Hereinbelow is explained a format of frames to be transmitted from the radio-signal transmitter 10x illustrated in FIG. 1, with reference to FIG. 3.

As illustrated in FIG. 3, the frame is comprised of a short preamble 310 or 320, a long preamble (LP) 311 or 321, a signal part 312 or 322, and a series of data parts including a data part 313 or 323 at a head.

The signal parts 312 and 322 include frame control signals. The short preamble 310 or 320, the long preamble 311 or 321, the signal part 312 or 322, and the data parts including the data part 313 or 323 at a head comprise a synchronous series.

The long preambles 311 and 321 defining training series are used for carrying out channel estimation. In FIG. 3, each of the long preamble series is expressed as follows.

lᵢ(1)Λlᵢ(G)

Herein, “i” indicates the number of a signal-transmission antenna, and “G” indicates a maximum length of a long preamble series.

In the MIMO-OFDM system, a radio-signal receiver is necessary to estimate a MIMO channel. An example of channel estimation to be carried out in the MIMO-OFDM system is suggested in the non-patent reference 3, in which an impulse response of a channel is estimated by virtue of MLE (Maximum Likelihood Estimation) of time domain. The suggested MLE is obtained by extending MLE used for a single antenna, suggested in the non-patent reference 4 as existing technique, to the MIMO-OFDM system.

Specifically, the technique suggested in the non-patent reference 4 makes it possible to estimate a MIMO channel without adding new training signals thereto, by assuming that an impulse response of a channel is within a guard interval (GI) of OFDM in time domain. In addition, it is possible to in advance prepare a generalized inverse matrix in a radio-signal receiver by selecting MLE as a process for estimating time domain, which is practically useful.

Hereinbelow is explained MLE in time domain with reference to FIG. 4.

In FIG. 4, the related radio-signal transmitter 10x is illustrated as including two radio-transmission antennas 115 and 125, and the related radio-signal receiver 20x is illustrated as including two radio-receipt antennas 214 and 224. However, it should be noted that both the related radio-signal transmitter 10x and the related radio-signal receiver 20x may be designed to include three or more antennas.

The radio-signal transmitter 10x including two radio-signal transmission antennas 115 and 125 transmits LP series l₁(1) to l₁(G) and l₂(1) to l₂(G).

The LP series l₁(1) to l₁(G) is characterized with the matrix (1) defined by LPs transmitted from an i-th antenna.

$${L}_{i} = [ \begin{matrix}{l}_{i} ( Δ ) & {l}_{i} ( Δ - 1 ) & Λ & {l}_{i} ( 1 ) \\ {l}_{i} ( Δ + 1 ) & {l}_{i} ( Δ ) & Λ & {l}_{i} ( 2 ) \\ M & M & M & M \\ {l}_{i} ( G ) & {l}_{i} ( G - 1 ) & Λ & {l}_{i} ( G - Δ + 1 )\end{matrix} ] \qquad ( 1 )$$

The expression (2) defines “hij” indicating an impulse response vector in a transmission path having a length Δ starting from a signal-transmission antenna “i” and terminating at a signal-receipt antenna “j”. In the expression (2), “T” indicates transposition of a vector.

hᵢⱼ=[hᵢⱼ(1) hᵢⱼ(2) Λhᵢⱼ(Δ)]^{T} (2)

Supposing that a signal vector having been received through a j-th antenna in the radio-signal receiver 20x is expressed as “rⱼ”, and a noise vector in the j-th antenna in the radio-signal receiver 20x is expressed as “nⱼ”, the signal vector rⱼ is defined with the expression (3), and the noise vector nⱼ is defined with the expression (4). Thus, the signal vector rⱼ can be expressed as shown in the expression (5).

$$\begin{matrix}{r}_{j} = {[ \begin{matrix}{r}_{j} ( Δ ) & {r}_{j} ( Δ + 1 ) & Λ & {r}_{j} ( G )\end{matrix} ]}^{T} & ( 3 ) \\ {n}_{j} = {[ \begin{matrix}{n}_{j} ( Δ ) & {n}_{j} ( Δ + 1 ) & Λ & {n}_{j} ( G )\end{matrix} ]}^{T} & ( 4 ) \\ {r}_{j} = [ \begin{matrix}{L}_{1} & {L}_{2}\end{matrix} ] [ \begin{matrix}{h}_{1 j} \\ {h}_{2 j}\end{matrix} ] + {n}_{j} = {Lh}_{j} + {n}_{j} & ( 5 )\end{matrix}$$

Herein, “L” and “hⱼ” are defined as follows.

$$L = [ \begin{matrix}{L}_{1} & {L}_{2}\end{matrix} ]$$

$${h}_{j} = [ \begin{matrix}{h}_{1 j} \\ {h}_{2 j}\end{matrix} ]$$

Supposing that the maximum likelihood estimation of “hⱼ” is expressed as follows,

\tilde{h}ⱼ

the maximum likelihood estimation of “hⱼ” can be obtained by minimizing the expression (6).

Jₘₗ=|L\tilde{h}ⱼ−rⱼ|² (6)

The expression (6) can be expressed in the form of a generalized inverse matrix, in which case, the expression (6) is expressed as follows.

X⁺=[L^{H}L]⁻¹L^{H} (7)

In the expression (7), “H” indicates conjugate transposition of a complex matrix.

The maximum likelihood estimation can be calculated in accordance with the following expression (8).

\tilde{h}ⱼ=X⁺rⱼ (8)

The above-mentioned matters are a gist of MLE.

If spread of singular values (condition number) in a generalized inverse matrix used in MLE were broad (broad spread of singular values is called “ill conditions”), there would be caused a problem that it is not possible to obtain an expected channel estimation accuracy in a low-SNR environment. As a solution to this problem, for instance, the non-patent reference 3 suggests a process of producing a new LP such that a number of conditions is made smaller in a radio-signal transmitter.

The above-mentioned non-patent references 1 to 4 are listed below.
[Non-patent reference 1] Y Asai, W. Jiang, T. Onizawa, A. Ohta and S. Aikawa, “A simple and feasible decision-feedback channel tracking scheme for MIMO-OFDM systems”, IEICE Trans. Commun., vol. E90-B, no. 5, pp. 1052-1060, May 2007
[Non-patent reference 2] K. Higuchi, A. Kishiyama, H. Taoka, H. Sawa, “Diversity technique in Evolved UTRA”, 2008 Electronics Data Communication Congress, Total Conference, Article collection CD-ROM, BS-1-3, March 2008
[Non-patent reference 3] Y. Ogawa, K. Nishino, T. Nishimura and T. Ohgane, “Channel estimation and signal detection for space division multiplexing in a MIMO OFDM system”, IEICE Trans. Commun., vol. E88-B, no. 1, pp. 10-18, January 2005
[Non-patent reference 4] M. Morelli and U. Mengali, “A comparison of pilot-aided channel estimation methods for OFDM systems”, IEEE Trans. Signal Process., vol. 49, no. 12, pp. 3065-3073, December 2001

In the related channel estimation to be carried out in accordance with MLE, a solution to a deteriorated accuracy of channel estimation in a low-SNR environment comprises newly designing a long preamble (LP) in which ill conditions are reduced. However, this solution is not useful to a system such as IEEE 802.11n in which a long preamble is already normalized.

Furthermore, any solution to be applied to a radio-signal receiver is not yet suggested.

### SUMMARY OF THE INVENTION

In view of the above-mentioned problems in the related art, it is an exemplary object of the present invention to provide a wireless communication system capable of enhancing an accuracy with which channel estimation is carried out even in a low-SNR environment to thereby make it possible to make long-distance wireless communication.

It is also an exemplary object of the present invention to provide a method of making wireless communication between a radio-signal receiver including at least two antennas and a radio-signal transmitter including at least two antennas in accordance with OFDM, a method of receiving radio-signals in a radio-signal receiver including at least two antennas from a radio-signal transmitter including at least two antennas in wireless communication made in accordance with OFDM, a computer-readable storage medium containing a set of instructions for causing a computer to carry out the method, a method of transmitting radio-signals from a radio-signal transmitter including at least two antennas to a radio-signal receiver including at least two antennas in wireless communication made in accordance with OFDM, and a computer-readable storage medium containing a set of instructions for causing a computer to carry out the method, all of which are capable of doing the same as mentioned above.

In a first exemplary aspect of the present invention, there is provided a wireless communication system comprising a radio-signal receiver including at least two antennas, and a radio-signal transmitter including at least two antennas and making wireless communication with the radio-signal receiver in accordance with orthogonal frequency division multiplexing system, the radio-signal receiver including a unit for making a generalized inverse matrix for carrying out maximum likelihood estimation, based on a matrix received from the radio-signal transmitter, the matrix indicating a training series used for carrying out channel estimation, a unit for carrying out singular value decomposition to the generalized inverse matrix, a unit for truncating singular values in the generalized inverse matrix in accordance with a threshold by which a singular value is turned to zero in a greater order, a unit for estimating an impulse-responsive vector, based on the generalized inverse matrix out of which the singular values were truncated, a unit for interpolating zero required for carrying out Fourier transform, to the impulse-responsive vector, and a unit for acquiring channel estimation of a frequency domain by carrying out Fourier transform, the radio-signal transmitter including a unit for quantifying spread of the singular values after the singular values were truncated in the radio-signal receiver, and optimizing the training series in accordance with the quantified spread of the singular values, to thereby make a new training series.

In the radio-signal receiver to be used in the wireless communication system in accordance with the present invention, a generalized inverse matrix comprised of a matrix indicative of training series is decomposed into singular values, and relatively great singular values are cut, that is, turned into zero, to thereby obtain a vector of received signals, and furthermore, estimation of an impulse response in a transmission path is carried out in accordance with the conventional MLE. Thereafter, a necessary number of zeros is interpolated to the impulse response vector, and then, Fourier transform is carried out to thereby have channel estimation of a frequency domain. Thus, it is possible to significantly improve MIMO-OFDM communication performance even in a low-SNR environment.

In the radio-signal transmitter to be used in the wireless communication system in accordance with the present invention, spread of the singular values is quantified after the singular values were truncated in the radio-signal receiver, to thereby make a new training series. As a result, it is possible to make a training series in which the step of truncating the singular values in the radio-signal receiver effectively functions, ensuring maximum improvement in an accuracy with which channel estimation is carried out.

It is preferable that the unit for quantifying the spread of the singular values calculates a singular value truncation number by which the estimation made in accordance with an estimated error of the channel estimation is minimized.

It is preferable that the radio-signal receiver further includes a unit for reconstructing the generalized inverse matrix and transmitting the thus reconstructed generalized inverse matrix to the unit for acquiring channel estimation.

In a second exemplary aspect of the present invention, there is provided a radio-signal receiver including at least two antennas through which the radio-signal receiver makes wireless communication with a radio-signal transmitter including at least two antennas, in accordance with orthogonal frequency division multiplexing system, including a unit for making a generalized inverse matrix for carrying out maximum likelihood estimation, based on a matrix received from the radio-signal transmitter, the matrix indicating a training series used for carrying out channel estimation, a unit for carrying out singular value decomposition to the generalized inverse matrix, a unit for truncating singular values in the generalized inverse matrix in accordance with a threshold by which a singular value is turned to zero in a greater order, a unit for estimating an impulse-responsive vector, based on the generalized inverse matrix out of which the singular values were truncated, a unit for interpolating zero required for carrying out Fourier transform, to the impulse-responsive vector, and a unit for acquiring channel estimation of a frequency domain by carrying out Fourier transform,

In a third exemplary aspect of the present invention, there is provided a radio-signal transmitter including at least two antennas through which the radio-signal transmitter makes wireless communication with a radio-signal receiver including at least two antennas, in accordance with orthogonal frequency division multiplexing system, including a unit for quantifying the spread of singular values, and optimizing a training series in accordance with the quantified spread of the singular values, to thereby make a new training series, the spread of singular values resulting from the truncation of singular values carried out in the radio-signal receiver which makes a generalized inverse matrix for carrying out maximum likelihood estimation, based on a training series used for carrying out channel estimation, decomposes the generalized inverse matrix into singular values, and truncates the singular values in accordance with a threshold by which a greatest singular value is turned to zero in turn among the singular values.

It is preferable that the unit for quantifying the spread of the singular values calculates a singular value truncation number by which estimation made in accordance with an estimated error of the channel estimation is minimized.

In a fourth exemplary aspect of the present invention, there is provided a method of making wireless communication between a radio-signal receiver including at least two antennas and a radio-signal transmitter including at least two antennas in accordance with orthogonal frequency division multiplexing system, including (a) making a generalized inverse matrix for carrying out maximum likelihood estimation, based on a matrix received from the radio-signal transmitter, the matrix indicating a training series used for carrying out channel estimation, (b) carrying out singular value decomposition to the generalized inverse matrix, (c) truncating singular values in the generalized inverse matrix in accordance with a threshold by which a singular value is turned to zero in a greater order, (d) estimating an impulse-responsive vector, based on the generalized inverse matrix out of which the singular values were truncated, (e) for interpolating zero required for carrying out Fourier transform, to the impulse-responsive vector, (f) acquiring channel estimation of a frequency domain by carrying out Fourier transform, and (g) quantifying spread of the singular values after the singular values were truncated, and optimizing the training series in accordance with the quantified spread of the singular values, to thereby make a new training series, the steps (a) to (f) being carried out in the radio-signal receiver, and the step (g) being carried out in the radio-signal transmitter.

In a fifth exemplary aspect of the present invention, there is provided a method of receiving radio-signals in a radio-signal receiver including at least two antennas from a radio-signal transmitter including at least two antennas in wireless communication made in accordance with orthogonal frequency division multiplexing system, including making a generalized inverse matrix for carrying out maximum likelihood estimation, based -on a matrix received from the radio-signal transmitter, the matrix indicating a training series used for carrying out channel estimation, decomposing the generalized inverse matrix into singular values, truncating the singular values in accordance with a threshold by which a greatest singular value is turned to zero in turn among the singular values, estimating an impulse-responsive vector, based on the generalized inverse matrix out of which the singular values were truncated, interpolating zero required for carrying out Fourier transform, to the impulse-responsive vector, and acquiring channel estimation of a frequency domain by carrying out Fourier transform.

In a sixth exemplary aspect of the present invention, there is provided a method of transmitting radio-signals from a radio-signal transmitter including at least two antennas to a radio-signal receiver including at least two antennas in wireless communication made in accordance with orthogonal frequency division multiplexing system, including the quantifying spread of singular values to thereby make a new training series, and optimizing a training series in accordance with the quantified spread of the singular values, to thereby make a new training series, the spread of singular values resulting from the truncation of singular values carried out in the radio-signal receiver which makes a generalized inverse matrix for carrying out maximum likelihood estimation, based on a training series used for carrying out channel estimation, decomposes the generalized inverse matrix into singular values, and truncates the singular values in accordance with a threshold by which a greatest singular value is turned to zero in turn among the singular values.

In a seventh exemplary aspect of the present invention, there is provided a computer-readable storage medium containing a set of instructions for causing a computer to carry out a method of receiving radio-signals in a radio-signal receiver including at least two antennas from a radio-signal transmitter including at least two antennas in wireless communication made in accordance with orthogonal frequency division multiplexing system, the set of instructions including making a generalized inverse matrix for carrying out maximum likelihood estimation, based on a matrix received from the radio-signal transmitter, the matrix indicating a training series used for carrying out channel estimation, carrying out singular value decomposition to the generalized inverse matrix, truncating singular values in the generalized inverse matrix in accordance with a threshold by which a singular value is turned to zero in a greater order, estimating an impulse-responsive vector, based on the generalized inverse matrix out of which the singular values were truncated, interpolating zero required for carrying out Fourier transform, to the impulse-responsive vector, and acquiring channel estimation of a frequency domain by carrying out Fourier transform.

In an eighth exemplary aspect of the present invention, there is provided a computer-readable storage medium containing a set of instructions for causing a computer to carry out a method of transmitting radio-signals from a radio-signal transmitter including at least two antennas to a radio-signal receiver including at least two antennas in wireless communication made in accordance with orthogonal frequency division multiplexing system, the set of instructions including the quantifying spread of singular values and optimizing the training series in accordance with the quantified spread of the singular values, to thereby make a new training series, the spread of singular values resulting from the truncation of singular values carried out in the radio-signal receiver which makes a generalized inverse matrix for carrying out maximum likelihood estimation, based on a training series used for carrying out channel estimation, decomposes the generalized inverse matrix into singular values, and truncates the singular values in accordance with a threshold by which a greatest singular value is turned to zero in turn among the singular values.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a related radio-signal transmitter to be used in a wireless communication system operating in accordance with MIMO-OFDM system.

FIG. 2 is a block diagram of a related radio-signal receiver to be used in a wireless communication system operating in accordance with MIMO-OFDM system.

FIG. 3 illustrates an example of a frame format.

FIG. 4 illustrates transmission paths in a wireless communication system operating in accordance with MIMO-OFDM system.

FIG. 5 is a block diagram of a wireless communication system in accordance with the exemplary embodiment of the present invention.

FIG. 6 is a block diagram of a radio-signal receiver to be used in a wireless communication system in accordance with the exemplary embodiment of the present invention.

FIG. 7 is a block diagram of the generalized inverse matrix optimizer which is a part of the radio-signal receiver illustrated in FIG. 6.

FIG. 8 is a block diagram of the channel estimation section which is a part of the radio-signal receiver illustrated in FIG. 6.

FIG. 9 is a block diagram of a radio-signal transmitter to be used in a wireless communication system in accordance with the exemplary embodiment of the present invention.

FIG. 10 is a flow chart showing steps to calculate an optimal singular value truncation number.

FIG. 11 shows parameters used for calculator simulation.

FIG. 12 is a graph showing the results of calculation of a number of partial conditions.

FIG. 13 is a graph used for obtaining an optimal singular value truncation number.

FIG. 14 is a graph showing characteristics of a packet error rate.

FIG. 15 is a block diagram showing an exemplary structure of a controller to be included in the generalized inverse matrix optimizer.

### DESCRIPTION OF THE EXEMPLARY EMBODIMENTS

Exemplary embodiments in accordance with the present invention will be explained hereinbelow with reference to drawings.

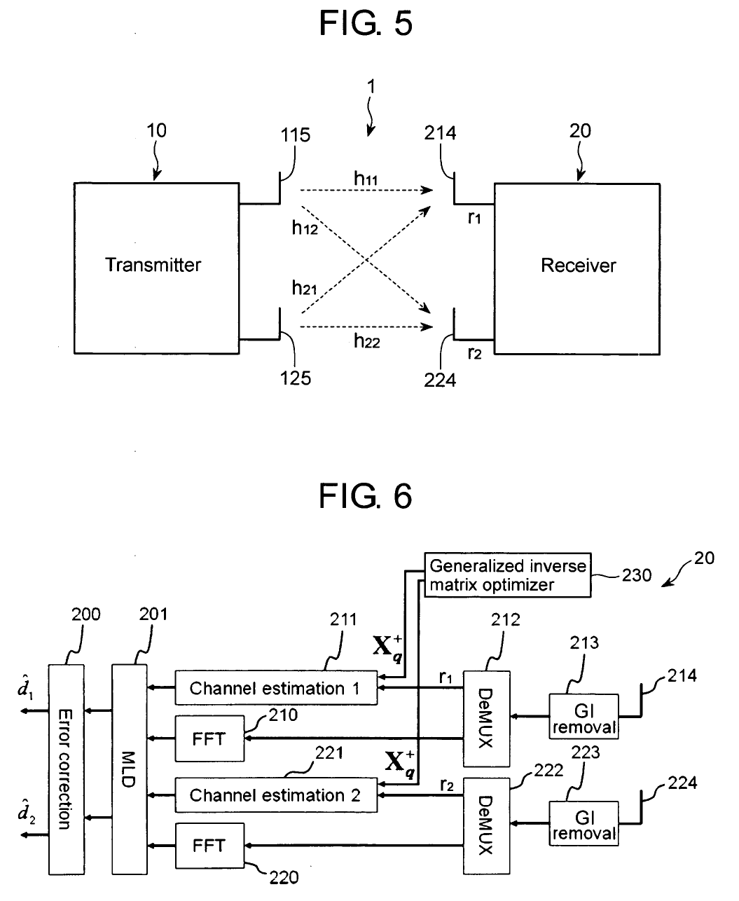

FIG. 5 is a block diagram of a wireless communication system 1 in accordance with an exemplary embodiment of the present invention.

As illustrated in FIG. 5, the wireless communication system 1 comprises a radio-signal transmitter 10 including two antennas 115 and 125, and a radio-signal receiver 20 including two antennas 214 and 224.

The radio-signal transmitter 10 and the radio-signal receiver 20 make wireless communication through their two antennas in accordance with MIMO-OFDM system.

First, the radio-signal receiver 20 is explained hereinbelow with reference to FIGS. 6, 7 and 8.

FIG. 6 is a block diagram of the radio-signal receiver 20.

As illustrated in FIG. 6, the radio-signal receiver 20 additionally includes a generalized inverse matrix optimizer 230 in comparison with the related radio-signal receiver 20 illustrated in FIG. 2. Accordingly, parts or elements that correspond to those of the radio-signal receiver 20x illustrated in FIG. 2 have been provided with the same reference numerals, and operate in the same manner as corresponding parts or elements in the radio-signal receiver 20x, unless explicitly explained hereinbelow.

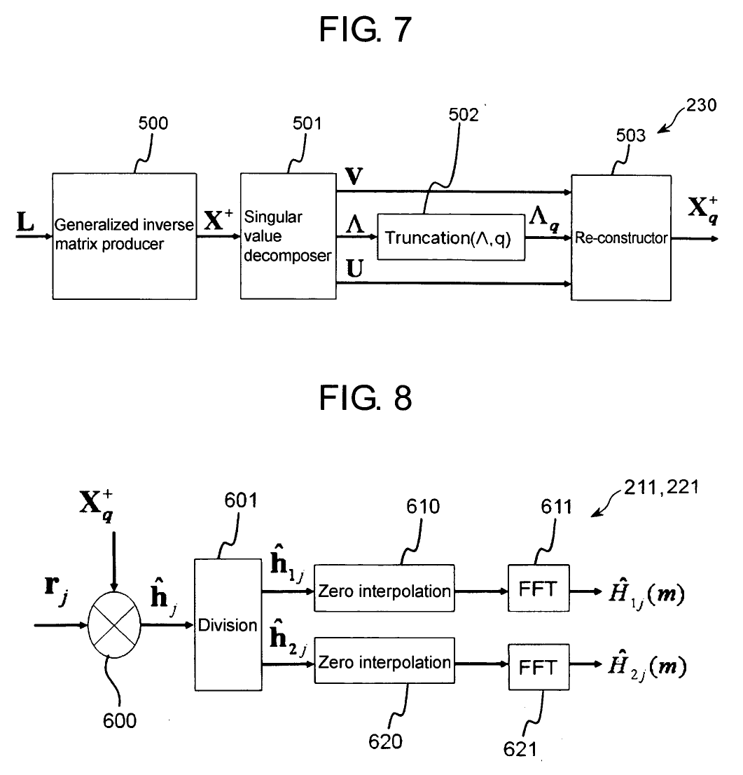

FIG. 7 is a block diagram of the generalized inverse matrix optimizer 230.

As illustrated in FIG. 7, the generalized inverse matrix optimizer 230 is comprised of a generalized inverse matrix producer 500, a singular value decomposer 501, a singular value truncater 502, and a re-constructor 503.

Hereinbelow is explained the operation of the generalized inverse matrix optimizer 230.

First, the generalized inverse matrix producer 500 reads LP matrix defined by the expression (1) thereinto, and then, produces a generalized inverse matrix X⁺, based on the LP matrix, in accordance with the expression (9).

X⁺=VΛU^{H} (9)

Then, the singular value decomposer 501 decomposes the generalized inverse matrix X⁺ output from the generalized inverse matrix producer 500, into singular values.

Herein, “M” is defined as follows.

M=G−Δ+1

Since “V” is expressed as a unitary matrix 2Δ×2Δ, and “U” is expressed as a unitary matrix M×M, “Λ” can be expressed in accordance with the expression (10).

$$Λ = [ \begin{matrix}{λ}_{1} & 0 & Λ & 0 & 0 & Λ & 0 \\ 0 & {λ}_{2} & Λ & 0 & 0 & Λ & 0 \\ M & M & O & M & M & M & M \\ 0 & 0 & Λ & {λ}_{2 Δ} & 0 & Λ & 0\end{matrix} ] \qquad ( 10 )$$

In the expression (10), λₖ indicates a singular value, and a relation among the singular values λ₁ to λ_{2Δ} is as follows.

λ₁<λ₂< . . . <λ_{2Δ}

Then, the singular value truncater 502 carries out the step of truncating singular values. Specifically, the singular value truncater 502 carries out the expression (11).

Λ_{q}=truncation(Λ,q) (11)

A sign “truncation (A, q)” means a step of picking “q” singular values in a greater order out of singular values included in a matrix “A”, and turn the picked “q” singular values into zero. “Λq” found at the left in the expression (11) means removal of “q” singular values in a greater order.

Receiving “V” and “U” from the singular value decomposer 501, and further receiving “Λq” from the singular value truncater 502, the re-constructor 503 re-constructs a generalized inverse matrix defined with the expression (12).

X_{q}⁺=VΛ_{q}U^{H} (12)

The re-constructor transmits the thus re-constructed generalized inverse matrix as LP series to both the first channel estimation section 211 and the second channel estimation section 221.

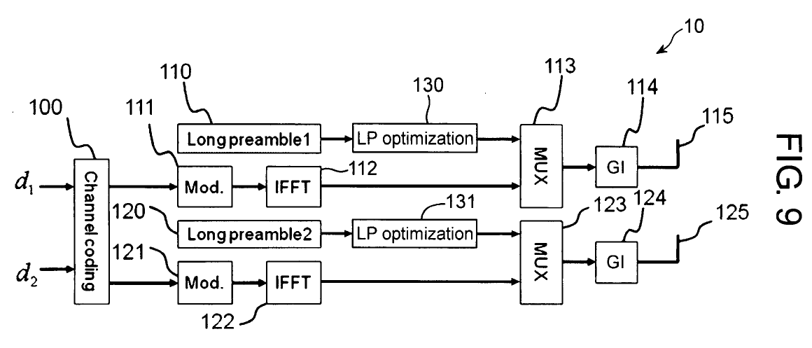

Hereinbelow are explained the first and second channel estimation sections 211 and 221 with reference to FIG. 8. In brief, each of the first and second channel estimation sections 211 and 221 estimates a transmission-path parameter in accordance with the generalized inverse matrix X_{q}⁺ transmitted from the generalized inverse matrix optimizer 230.

FIG. 8 is a block diagram of each of the first and second channel estimation sections 211 and 221.

As illustrated in FIG. 8, each of the first and second channel estimation sections 211 and 221 is comprised of a matrix multiplier 600, a divider 601, a first zero-interpolator 610, a second zero-interpolator 620, a first Fourier transform section 611, and a second Fourier transform section 621.

Hereinbelow is explained the operation of the first and second channel estimation sections 211 and 221.

First, the matrix multiplier 600 carries out the expression (13) to thereby have a newly estimated impulse response “ĥj”.

ĥⱼ=X_{q}⁺rⱼ (13)

In the expression (13), “X_{q}⁺” indicates the above-mentioned LP series output from the generalized inverse matrix optimizer 230, and “rⱼ” indicates a vector of a signal received through a j-th antenna in the radio-signal receiver 20.

The divider 601 receives “ĥj” from the matrix multiplier 600, and calculates “ĥ₁j” and “ĥ₂j” in accordance with the expression (14).

$${\hat{h}}_{j} = [ \begin{matrix}{\hat{h}}_{1 j} \\ {\hat{h}}_{2 j}\end{matrix} ] \qquad ( 14 )$$

Herein, “ĥ₁j” indicates a vector indicative of an impulse response between the antenna 115 of the radio-signal transmitter 10 and a j-th antenna in the radio-signal receiver 20, and “ĥ₂j” indicates a vector indicative of an impulse response between the antenna 125 of the radio-signal transmitter 10 and a j-th antenna in the radio-signal receiver 20.

The divider 601 transmits the thus calculated impulse response vectors “ĥ₁j” and “ĥ₂j” to the first and second zero-interpolators 610 and 620, respectively.

The first and second zero-interpolators 610 and 620 add (or interpolate) zero to the impulse response vectors “ĥ₁j” and “ĥ₂j”, respectively. In other words, the first and second zero-interpolators 610 and 620 extend the impulse response vectors “ĥ₁j” and “ĥ₂j” such that the first and second Fourier transform sections 611 and 621 are able to carry out Fourier transform to them.

The first and second zero-interpolators 610 and 620 transmit the impulse response vectors “ĥ₁j” and “ĥ₂j” to the first and second Fourier transform sections 611 and 621, respectively.

Then, the first and second Fourier transform sections 611 and 621 apply Fourier transform to the impulse response vectors “ĥ₁j” and “ĥ₂j” to thereby have both a frequency response Ĥ₁ⱼ(m) between the antenna 115 of the signal-transmitter 10 and a j-th antenna in the radio-signal receiver 20, and a frequency response Ĥ₂ⱼ(m) between the antenna 125 of the signal-transmitter 10 and a j-th antenna in the radio-signal receiver 20.

Herein, “m” indicates a sub-carrier number.

After the first and second Fourier transform sections 611 and 621 extended the impulse response vectors, the first and second channel estimation sections 211 and 221 estimate a transmission parameter in accordance with MLE.

As explained above, in the radio-signal receiver 20, the generalized inverse matrix producer 500 produces a generalized inverse matrix for estimating a maximum likelihood, the singular value decomposer 501 decomposes the generalized inverse matrix into singular values, the singular value truncater 502 truncates singular values, that is, turns singular values into zero in a greater order, the matrix multiplier 600 estimates an impulse response vector, and the first and second zero-interpolators extend the impulse response vector such that the first and second Fourier transform sections 611 and 621 can apply Fourier transform to the impulse response vector, and the first and second Fourier transform sections 611 and 621 estimate a channel in a frequency domain. Thus, the radio-signal receiver 20 makes it possible to enhance an accuracy with which a channel is estimated.

Hereinbelow is explained how to obtain an optimal number of singular values to be truncated, which maximizes an accuracy with which a channel is estimated.

First, the expression (5) is put into the expression (13) to thereby have the expression (15).

ĥⱼ=X_{q}⁺rⱼ=X_{q}⁺Lhⱼ+X_{q}⁺nⱼ (15)

In order to consider only influences caused by noises in the expression (15), “e_{n,j}” is defined as follows.

e_{n,j}=X_{q}⁺nⱼ

A function Jn is defined with the expression (16).

$${J}_{n} = E [ {e}_{n}^{H} {e}_{n} ] = {σ}_{n}^{2} {\sum }_{k = 1}^{2 Δ - q} {λ}_{k}^{2} \qquad ( 16 )$$

In the expression (16), “σₙ²” indicates noise power. It is understood in view of the expression (16) that it is possible to reduce noise influences by truncating large singular values.

If noise factors were zero in the expression (15), “e_{n,j}” can be expressed with the expression (17).

e_{h,j}=ĥⱼ−hⱼ=(X_{q}⁺L−I)hⱼ (17)

The expression (17) is defined as an estimated error in channel estimation.

Accordingly, the function Jₕ can be obtained in accordance with the expression (18).

Jₕ=E[e_{h,j}^{H}e_{h,j}]=tr[CₕVI_{qq}V^{H}] (18)

Herein, “tr[ - - - ]” indicates a trace of a matrix.

A covariance matrix of an impulse response of a channel “Cₕ” is defined as follows.

Cₕ=E[hⱼhⱼ^{H}]

Accordingly, if fluctuation in each element of the impulse response vector is statistically independent of one another, “Cₕ” is defined as a diagonal matrix in which power delay profiles are arranged as diagonal factors.

“I_{qq}” found in the expression (18) indicates a square matrix in which diagonal factors arranged before (2Δ−q)-th row and (2Δ−q)-th line in an identity matrix are all zero. It is understood in view of the expression (18) that the function Jₕ increases along with the singular value truncation number. That is, it is preferable that the singular value truncation number is possibly small in order to maintain a required accuracy with which channel estimation is carried out.

In view of the explanation made above, as a singular value truncation number increases, the function Jₙ makes a reducing function, and the function Jₕ makes an increasing function. Accordingly, defining a performance function J as J=Jₙ+Jₕ, it is possible to have a singular value truncation number which minimizes the performance function J, by using the expressions (16) and (18).

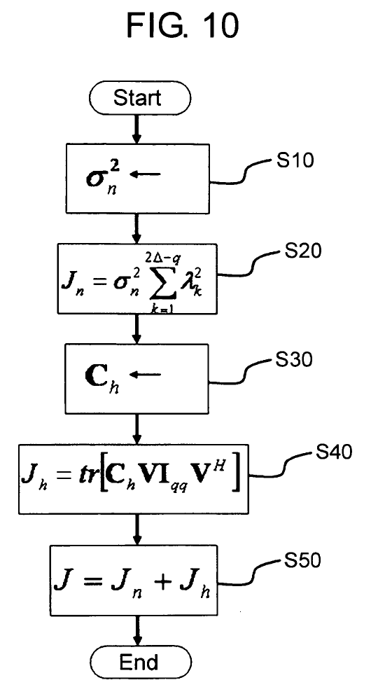

FIG. 10 is a flow chart showing steps to obtain an optimal singular value truncation number. Hereinbelow is explained a process for obtaining an optimal singular value with reference to FIG. 10.

As illustrated in FIG. 10, noise power is given, based on SNR of the radio-signal receiver 10, in step S10.

Since singular value decomposition has been already carried out by the singular value decomposer 501, and hence, all singular values λₖ included in a generalized inverse matrix have been already obtained, as having been explained with reference to FIG. 7, the reducing functions Jₙ are calculated for all of singular value truncation numbers “q” through the use of the singular values λₖ, in step S20.

Then, there is defined a covariance matrix Cₕ in step S30. If power delay profile had been already obtained, the power delay profile is used as the covariance matrix. However, if power delay profile were unknown, an identity matrix is used as a covariance matrix. It is known that the final solution is hardly influenced, even if an identity matrix were used as a covariance matrix.

Since the unitary matrix V have been already provided by the singular value decomposer 501, the increasing function Jₕ in association with the singular value truncation number “q” is calculated in step S40.

Then, the function J in association with all of the singular value truncation numbers “q” is calculated in step S50, and then, there is calculated a singular value truncation number “qₒₚₜ” which minimizes the function J.

In the way as mentioned above, it is possible to have a singular value truncation number which minimizes the function J.

FIG. 9 is a block diagram of the radio-signal transmitter 10. Hereinbelow is explained the radio-signal transmitter 10 with reference to FIG. 9.

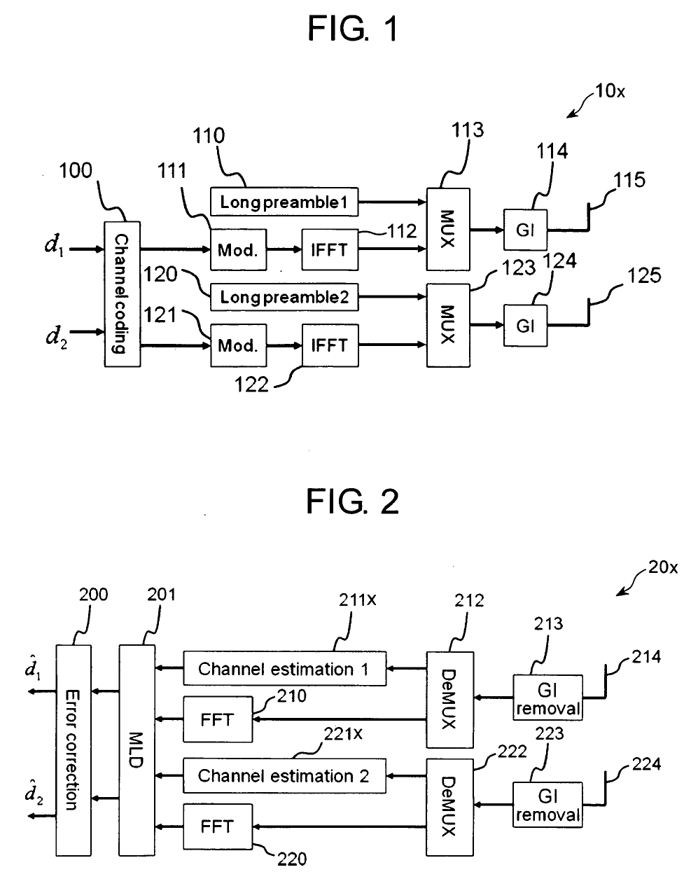

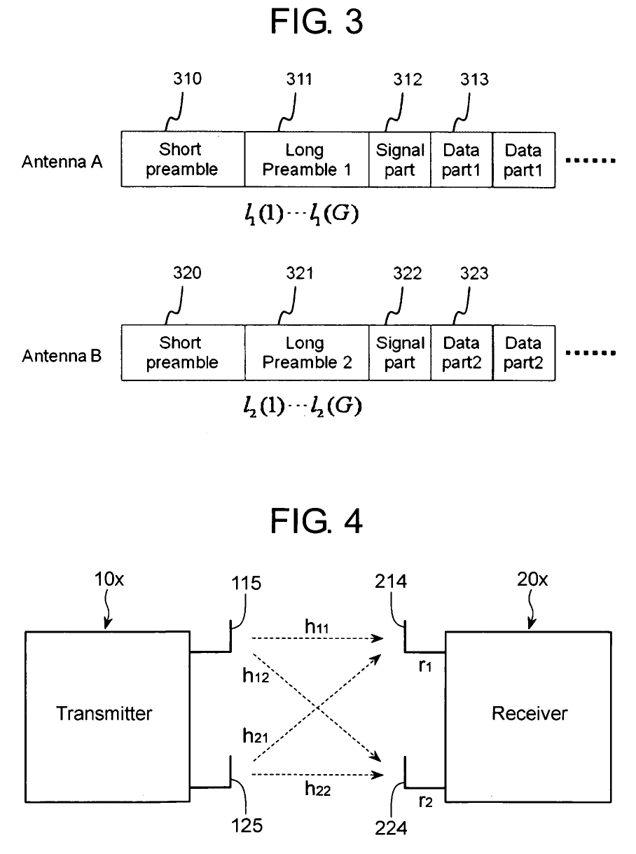

The radio-signal transmitter 10 illustrated in FIG. 9 is designed to additionally include a first LP optimizer 130 and a second LP optimizer 131 in comparison with the radio-signal transmitter 10x illustrated in FIG. 1. Accordingly, parts or elements that correspond to those of the radio-signal transmitter 10x illustrated in FIG. 1 have been provided with the same reference numerals, and operate in the same manner as corresponding parts or elements in the radio-signal transmitter 10x, unless explicitly explained hereinbelow.

Each of the first LP optimizer 130 and the second LP optimizer 131 is designed to quantify spread-of singular values in LP matrix output from the first and second preamble producers 110 and 120, and optimize the thus quantified spread of singular values, to thereby make a new LP matrix.

Hereinbelow is explained a process of quantitatively estimating spread of singular values in a generalized inverse matrix having been re-constructed by singular value truncation.

In general, a condition number CN defined as follows is frequently used for knowing spread of singular values of a matrix.

CN=λ_{2Δ}/λ₁

Since it is necessary in the present invention to further consider spread of singular values after singular values were truncated, a parameter comprised of a partial condition number (hereinafter, referred to simply as “PCN”) is newly defined in accordance with the expression (19).

$$PCN ( q ) = \frac{{λ}_{2 Δ - q}}{{λ}_{1}} \qquad ( 19 )$$

For instance, if “q” is equal to zero (q=0), PCN is coincident with a conventional condition number CN, and if “q” is equal to one (q=1), PCN may be considered as a condition number CN from which a maximum singular value is removed. That is, it is possible by monitoring PCN(q) to estimate how much ill conditions are relaxed after singular values were truncated.

In addition, it is also possible by estimating PCN(q) to design a LP matrix which presents a smaller singular value truncation number, when a LP matrix in the radio-signal transmitter 10 is designed.

As mentioned so far, the radio-signal transmitter 10 in the present exemplary embodiment causes the first and second LP optimizers 130 and 131 to quantify the spread of singular values in a LP matrix, optimize the thus quantified spread of singular values, and transmit the thus optimized spread of singular values to the signal-receiver 20 as a new training series. This results in that singular value truncation can be effectively carried out in the radio-signal receiver 20.

Hereinbelow is explained a specific example of the wireless communication system 1 in accordance with the present exemplary embodiment.

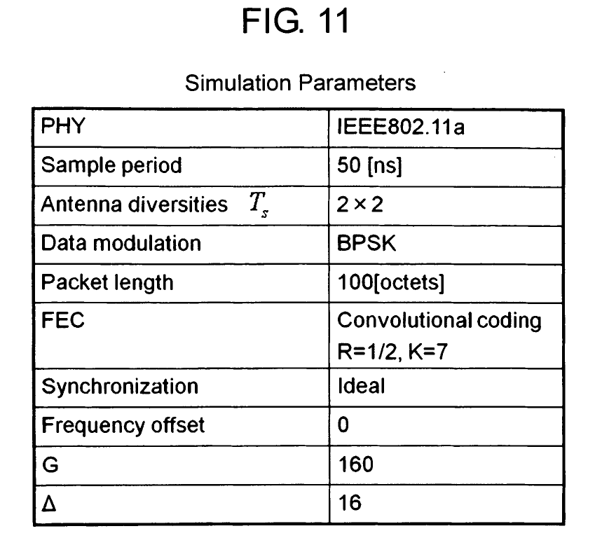

FIG. 11 shows simulation parameters.

In order to test the advantages of channel estimation carried out in low-SNR environment, BPSK is used for primary modulation, and there is assumed 2×2 transmission/receipt diversity making use of a space time block coding (hereinafter, referred to simply as “STBC”), in the example.

Based on cyclic shifts (hereinafter, referred to simply as “CS”) of a LP of a first antenna (the antenna 115), a LP of a second antenna (the antenna 125) was designed. A transmission path was designed to have an impulse response length Δ being equal to sixteen (Δ=16), and power delay profile was designed to exponentially attenuate. Each element of the impulse response vector was designed to fluctuate independently of one another by Rayleigh fading, and correlation among antennas was assumed as no correlation.

First, hereinbelow is explained an example of a method of designing a LP of the second antenna through the use of the partial condition number PCN(q).

In the example, a LP of the second antenna is comprised of a series obtained by cyclically shifting a LP of the first antenna. In the case that a number of antennas through which radio-signals are transmitted is two (2), there exists 159 patterns as a LP structure in accordance with a number of cyclic shifts.

However, since there does not exist an inverse matrix for “L^{H}L” in the expression (7) when CS is in the range of 1 to 15 and CS is in the range of 145 to 159, analysis is made only for a case in which CS is in the range of 16 to 144.

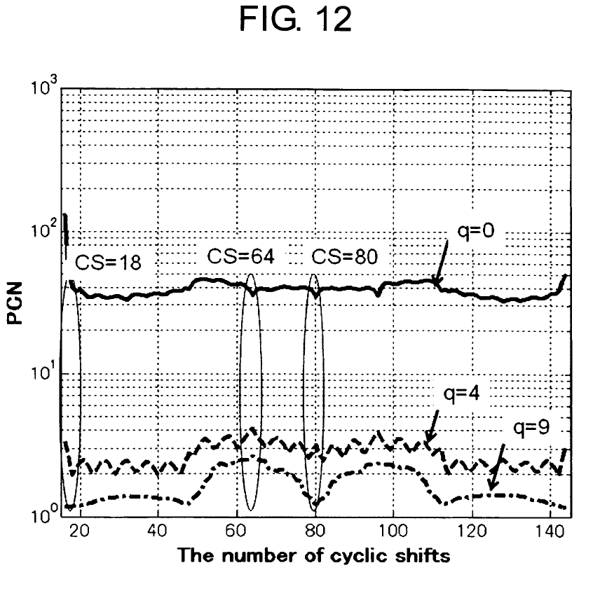

FIG. 12 is a graph showing the results of calculation of PCN(0), PCN(4) and PCN(9) when CS is in the range of 16 to 144.

Since PCN(0) hardly changes except when CS is equal to 16 (CS=16), it is not possible at a glance to identify in which CS ill condition occurs.

In contrast, it is understood in PCN(4) and PCN(9) that a condition number is relaxed after singular values were truncated, for instance, when CS is equal to eighteen (CS=18).

Furthermore, it is understood that a condition number is relaxed, if a singular value truncation number is high (for instance, see CS=80).

Specifically, when CS is equal to 18 or 80, it is considered that singular value truncation effectively works. In addition, when CS is equal to eighteen (CS=18), PCN is close to one (1) in the case that “q” is equal to four (4) or nine (9) at which singular value truncation is carried out. This suggests that it is possible to carry out channel estimation more accurately when CS is equal to eighteen (CS=18) than when CS is equal to a number other than eighteen.

Hereinbelow is explained a specific example of a method of obtaining an optimal singular value truncation number for LP candidates (for instance, LPs in the case that CS is equal to 18, 64 or 80).

A performance function J is calculated in accordance with the process illustrated in FIG. 10 for cases wherein CS is equal to 18, 64 or 80.

In this example, “σₙ²” is defined to be equal to one (1), and “Cₕ” is defined to be equal to I.

σₙ²=1 Cₕ=I

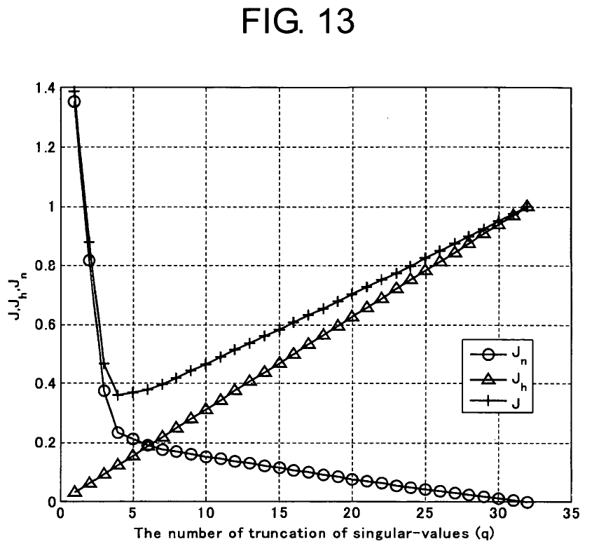

FIG. 13 shows a performance function J relating to a LP structure in the case that CS is equal to eighteen (CS=18).

In FIG. 13, a reducing function Jₙ and an increasing function Jₕ are also illustrated for comparison.

As illustrated in FIG. 13, it is understood that “qₒₚₜ” is equal to four (4) when CS is equal to eighteen (18). That is, an optimal singular value truncation number is four (4). Similarly, it is possible to have an optimal singular value truncation number for a LP when CS is equal to 64 or 80. That is, an optimal singular value truncation number “qₒₚₜ” is equal to five (5) when CS is equal to 64 or 80.

Hereinbelow is explained the packet error rate characteristics of the wireless communication system operating in accordance with MIMO-OFDM system, in accordance with the present exemplary embodiment, based on the results of computer simulation.

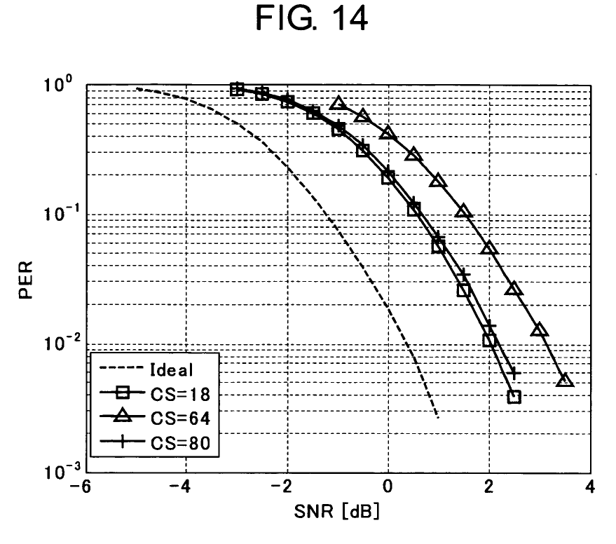

FIG. 14 is a graph showing packet error rate characteristics obtained by computer simulation through the use of the simulation parameters shown in FIG. 11.

In FIG. 14, a broken line indicates a packet error rate characteristic when an ideal channel estimation is applied, which is the characteristic the wireless communication system targets. Other characteristics are packet error rate characteristics obtained when CS is equal to 18 (qₒₚₜ=4), 64 (qₒₚₜ=5) or 80 (qₒₚₜ=5).

As is obvious in view of FIG. 12, since a LP in which CS is equal to 64 has a greater PCN than other LPs, a packet error in the LP is high. In contrast, LPs in which CS is equal to 18 or 80 are given improvement in packet error rate characteristics by carrying out optimal singular value truncation. In particular, since a smaller singular value truncation number can be applied to a LP in which CS is equal to 18, the LP has lower packet error rate characteristics. In addition, these performances can be accomplished even in low-SNR environment, specifically, even when SNR is in the range of 0 to 3 dB.

In the above-mentioned exemplary embodiment, the generalized inverse matrix optimizer 230 which is a part of the radio-signal receiver 20 may be designed to include a controller for controlling the operations of the generalized inverse matrix producer 500, the singular value decomposer 501, the singular value truncater 502, and the re-constructor 503.

Such a controller may be accomplished by a data processor and a program to carry out the functions of the generalized inverse matrix optimizer 230.

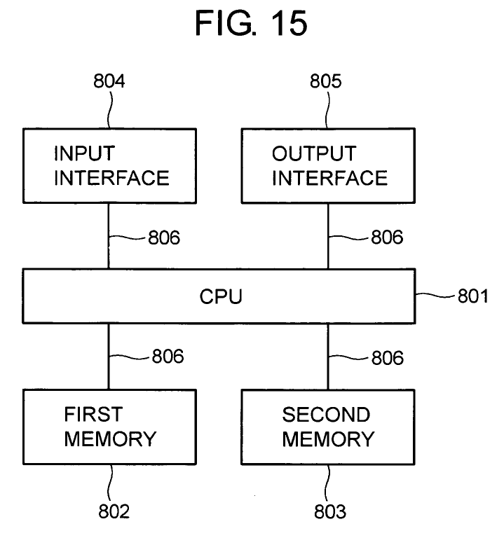

FIG. 15 is a block diagram showing an exemplary structure of the controller to be included in the generalized inverse matrix optimizer 230.

As illustrated in FIG. 15, the controller is comprised of a central processing unit (CPU) 801, a first memory 802, a second memory 803, an input interface 804 through which a command and/or data are(is) input into the central processing unit 801, an output interface 804 through which a result of steps having been executed by the central processing unit 801 is output, and a bus 806 through which the central processing unit 801 is electrically connected with the first memory 802, the second memory 803, the input interface 804, and the output interface 805.

Each of the first and second memories 802 and 803 is comprised of a semiconductor memory such as a read only memory (ROM), a random access memory (RAM) or an IC memory card, or a storage device such as a flexible disc, a hard disc or an optic magnetic disc.

In the exemplary structure, the first memory 802 comprises a read only memory (ROM), and the second memory 803 comprises a random access memory (RAM).

The first memory 802 stores therein a program for causing the central processing unit 801 to carry out the functions of the generalized inverse matrix optimizer 230.

Such a program may be presented through a recording medium readable by a computer.

The second memory 803 stores therein various data and parameters, and presents a working area to the central processing unit 801. The central processing unit 801 reads the program out of the first memory 802, and executes the program. Thus, the central processing unit 801 operates in accordance with the program stored in the first memory 801.

Specifically, the central processing unit 801, the first memory 802, and the second memory 803 may be designed to functionally define the controller.

Similarly to the generalized inverse matrix optimizer 230, each of the first and second LP optimizers 131 and 132 may be designed to include a controller for controlling the operations thereof.

Such a controller may be designed to include the same structure as the structure illustrated in FIG. 15.

The exemplary advantages obtained by the above-mentioned exemplary embodiments are described hereinbelow.

In the wireless communication system in accordance with the above-mentioned exemplary embodiment, a training series is optimized in the radio-signal receiver, and MIMO channel estimation is carried out in the radio-signal receiver in accordance with MLE through the use of a generalized inverse matrix having resistance to noise enhanced by carrying out the step of truncating singular values in the optimized manner, resulting in that it is possible to remarkably improve MIMO-OFDM communication performance even in low-SNR environment. Furthermore, it is also possible to suppress operation load in the wireless communication system from exceeding operation load in the conventional MLE. Thus, the wireless communication system in accordance with the above-mentioned exemplary embodiment improves the accuracy with which channel estimation is carried out, to thereby make it possible to make long-distance communication even in low-SNR environment.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

This application is based upon and claims the benefit of priority from Japanese Patent Application No. 2008-227454 filed on Sep. 4, 2008, the entire disclosure of which, including specification, claims, drawings and summary, is incorporated herein by reference in its entirety.

What is claimed is:

1. A wireless communication system comprising a radio-signal receiver including at least two antennas, and a radio-signal transmitter including at least two antennas and making wireless communication with said radio-signal receiver in accordance with orthogonal frequency division multiplexing system,
said radio-signal receiver including:
means for making a generalized inverse matrix for carrying out maximum likelihood estimation, based on a matrix received from said radio-signal transmitter, said matrix indicating a training series used for carrying out channel estimation,
means for carrying out singular value decomposition to said generalized inverse matrix,
means for truncating singular values in said generalized inverse matrix in accordance with a threshold by which a singular value is turned to zero in a greater order,
means for estimating an impulse-response vector, based on said generalized inverse matrix out of which said singular values were truncated,
means for interpolating zero required for carrying out Fourier transform, to said impulse-response vector, and
means for acquiring channel estimation of a frequency domain by carrying out Fourier transform,
said radio-signal transmitter including means for quantifying the spread of said singular values after said singular values were truncated in said radio-signal receiver, and optimizing said training series in accordance with the quantified spread of said singular values, to thereby make a new training series.

2. The wireless communication system as set forth in claim 1, wherein said means for quantifying spread of said singular values calculates a singular value truncation number by which estimation made in accordance with an estimated error of said channel estimation is minimized.

3. The wireless communication system as set forth in claim 1, wherein said radio-signal receiver further includes means for reconstructing said generalized inverse matrix and transmitting the thus reconstructed generalized inverse matrix to said means for acquiring channel estimation.

4. A radio-signal receiver including at least two antennas through which said radio-signal receiver makes wireless communication with a radio-signal-transmitter including at least two antennas, in accordance with orthogonal frequency division multiplexing system, comprising:
means for making a generalized inverse matrix for carrying out maximum likelihood estimation, based on a matrix received from said radio-signal transmitter, said matrix indicating a training series used for carrying out channel estimation,
means for carrying out singular value decomposition to said generalized inverse matrix,
means for truncating singular values in said generalized inverse matrix in accordance with a threshold by which a singular value is turned to zero in a greater order,
means for estimating an impulse-response vector, based on said generalized inverse matrix out of which said singular values were truncated,
means for interpolating zero required for carrying out Fourier transform, to said impulse-response vector, and
means for acquiring channel estimation of a frequency domain by carrying out Fourier transform,

5. A radio-signal transmitter including at least two antennas through which said radio-signal transmitter makes wireless communication with a radio-signal receiver including at least two antennas, in accordance with orthogonal frequency division multiplexing system, comprising:
means for quantifying spread of singular values, and optimizing a training series in accordance with the quantified spread of said singular values, to thereby make a new training series,
said spread of singular values being resulted from truncation of singular values carried out in said radio-signal receiver which makes a generalized inverse matrix for carrying out maximum likelihood estimation, based on a training series used for carrying out channel estimation, decomposes said generalized inverse matrix into singular values, and truncates said singular values in accordance with a threshold by which a greatest singular value is turned to zero in turn among said singular values.

6. The radio-signal transmitter as set forth in claim 5, wherein said means for quantifying spread of said singular values calculates a singular value truncation number by which estimation made in accordance with an estimated error of said channel estimation is minimized.

7. A method of making wireless communication between a radio-signal receiver including at least two antennas and a radio-signal transmitter including at least two antennas in accordance with orthogonal frequency division multiplexing system, comprising:
(a) making a generalized inverse matrix for carrying out maximum likelihood estimation, based on a matrix received from said radio-signal transmitter, said matrix indicating a training series used for carrying out channel estimation;
(b) carrying out singular value decomposition to said generalized inverse matrix;
(c) truncating singular values in said generalized inverse matrix in accordance with a threshold by which a singular value is turned to zero in a greater order;
(d) estimating an impulse-response vector, based on said generalized inverse matrix out of which said singular values were truncated;
(e) for interpolating zero required for carrying out Fourier transform, to said impulse-response vector;
(f) acquiring channel estimation of a frequency domain by carrying out Fourier transform; and
(g) quantifying spread of said singular values after said singular values were truncated, and optimizing said training series in accordance with the quantified spread of said singular values, to thereby make a new training series,
said steps (a) to (if being carried out in said radio-signal receiver, and said step (g) being carried out in said radio-signal transmitter.

8. A method of receiving radio-signals in a radio-signal receiver including at least two antennas from a radio-signal transmitter including at least two antennas in wireless communication made in accordance with orthogonal frequency division multiplexing system, comprising:
making a generalized inverse matrix for carrying out maximum likelihood estimation, based on a matrix received from said radio-signal transmitter, said matrix indicating a training series used for carrying out channel estimation;
carrying out singular value decomposition to said generalized inverse matrix;
truncating singular values in said generalized inverse matrix in accordance with a threshold by which a singular value is turned to zero in a greater order;
estimating an impulse-response vector, based on said generalized inverse matrix out of which said singular values were truncated;
interpolating zero required for carrying out Fourier transform, to said impulse-response vector; and
acquiring channel estimation of a frequency domain by carrying out Fourier transform.

9. A method of transmitting radio-signals from a radio-signal transmitter including at least two antennas to a radio-signal receiver including at least two antennas in wireless communication made in accordance with orthogonal frequency division multiplexing system, comprising:
quantifying spread of singular values to thereby make a new training series, and optimizing a training series in accordance with the quantified spread of said singular values, to thereby make a new training series,
said spread of singular values being resulted from truncation of singular values carried out in said radio-signal receiver which makes a generalized inverse matrix for carrying out maximum likelihood estimation, based on a training series used for carrying out channel estimation, decomposes said generalized inverse matrix into singular values, and truncates said singular values in accordance with a threshold by which a greatest singular value is turned to zero in turn among said singular values.

10. A computer-readable storage medium containing a set of instructions for causing a computer to carry out a method of receiving radio-signals in a radio-signal receiver including at least two antennas from a radio-signal transmitter including at least two antennas in wireless communication made in accordance with orthogonal frequency division multiplexing system, the set of instructions comprising:
making a generalized inverse matrix for carrying out maximum likelihood estimation, based on a matrix received from said radio-signal transmitter, said matrix indicating a training series used for carrying out channel estimation;
carrying out singular value decomposition to said generalized inverse matrix;
truncating singular values in said generalized inverse matrix in accordance with a threshold by which a singular value is turned to zero in a greater order;
estimating an impulse-response vector, based on said generalized inverse matrix out of which said singular values were truncated;
interpolating zero required for carrying out Fourier transform, to said impulse-response vector; and
acquiring channel estimation of a frequency domain by carrying out Fourier transform.

11. A computer-readable storage medium containing a set of instructions for causing a computer to carry out a method of transmitting radio-signals from a radio-signal transmitter including at least two antennas to a radio-signal receiver including at least two antennas in wireless communication made in accordance with orthogonal frequency division multiplexing system, the set of instructions comprising:
quantifying spread of singular values and optimizing said training series in accordance with the quantified spread of said singular values, to thereby make a new training series,
said spread of singular values being resulted from truncation of singular values carried out in said radio-signal receiver which makes a generalized inverse matrix for carrying out maximum likelihood estimation, based on a training series used for carrying out channel estimation, decomposes said generalized inverse matrix into singular values, and truncates said singular values in accordance with a threshold by which a greatest singular value is turned to zero in turn among said singular values.
